(19) United States
(12) Patent Application Publication
(10) Pub. No.: US 2026/0051007 A1
(43) Pub. Date: Feb. 19, 2026

(54) AUTONOMOUS AI-DRIVEN NEGOTIATION AND TRANSACTION FACILITATION IN eCOMMERCE PROCUREMENT ENVIRONMENTS

(71) Applicant: International Business Machines Corporation, Armonk, NY (US)

(72) Inventors: Subson Mittal, Wayne, NJ (US); Elezaveta Koumpan, Perth Road (CA); Jeremy Ray Fox, Georgetown, TX (US); Krishna Manish Sheth, Lowell, MA (US)

(21) Appl. No.: 18/802,296

(22) Filed: Aug. 13, 2024

(51) Int. Cl. G06Q 50/18; G06Q 30/0601

(52) U.S. Cl. CPC G06Q 50/188; G06Q 30/0611

(57) ABSTRACT

A method for autonomous facilitation of procurement negotiation and transaction in an eCommerce environment includes obtaining prerequisite information related to an eCommerce transaction, wherein the prerequisite information includes real-time market data, pricing trends and product availability, analyzing the prerequisite information using advance data analytic and machine learning algorithms to generate analyzed information responsive to eCommerce market trends and demand patterns related to the eCommerce transaction, conducting a negotiation between eCommerce buyers and eCommerce sellers using a machine learning algorithm to generate negotiated terms between potential eCommerce buyer-seller pairs and matching an eCommerce buyer with an eCommerce seller based on a requirement of the eCommerce buyer, an offering of the eCommerce seller, and the negotiated terms.

### BACKGROUND

The present invention generally relates to eCommerce procurement, and more particularly to a method for automating negotiations and buyer-seller matching in an eCommerce procurement environment.

In the realm of eCommerce, procurement presents a significant challenge due to the dynamic nature of market prices and product availability. Buyers consistently seek the most advantageous deals, which requires balancing optimal pricing with timely acquisition. Given the vast array of sellers and fluctuating market conditions, this process is often time-consuming and complex. The task of sifting through numerous offerings to find the ‘best fit’ is not only labor-intensive, but also fraught with suboptimal decisions and the potential for missed opportunities. On the seller's side, as each seller competes in a crowded marketplace, striving to attract buyers while simultaneously adjusting to rapidly changing market trends, the challenge lies in efficiently responding to market demand and effectively presenting their offerings to the right buyers at the right time.

This situation necessitates a high level of market awareness and agility in presenting and modifying offers to meet the buyer's needs, which can be an overwhelming task, often leading to less-than-ideal match making and negotiation outcomes.

### SUMMARY

A method for autonomous facilitation of procurement negotiation and transaction in an eCommerce environment is provided and includes obtaining prerequisite information related to an eCommerce transaction, wherein the prerequisite information includes real-time market data, pricing trends and product availability, analyzing the prerequisite information using advance data analytic and machine learning algorithms to generate analyzed information responsive to eCommerce market trends and demand patterns related to the eCommerce transaction, conducting a negotiation between eCommerce buyers and eCommerce sellers using a machine learning algorithm to generate negotiated terms between potential eCommerce buyer-seller pairs and matching an eCommerce buyer with an eCommerce seller based on a requirement of the eCommerce buyer, an offering of the eCommerce seller, and the negotiated terms.

Embodiments of the invention are also directed to computer-implemented methods and computer program products having substantially the same features and functionality as the computer system described above.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 shows a block diagram illustrating the software architecture of an AI eCommerce Negotiation System, in accordance with an embodiment of the invention;

FIG. 2 shows a block diagram illustrating the operational flow of a Market Analysis Software Module for use with the AI eCommerce Negotiation System of FIG. 1, in accordance with an embodiment of the invention;

FIG. 3 shows a block diagram illustrating the operational flow of an AI Negotiator Software Module for use with the AI eCommerce Negotiation System of FIG. 1, in accordance with an embodiment of the invention;

FIG. 4 shows a block diagram illustrating the operational flow of a Buyer-Seller Matching Software Module for use with the AI eCommerce Negotiation System of FIG. 1, in accordance with an embodiment of the invention;

FIG. 5 shows a block diagram of an example computer system for use in accordance with one or more embodiments of the invention; and

FIG. 6 shows a block diagram illustrating a method for Autonomous Facilitation of Procurement Negotiation and Transaction in an eCommerce Environment, in accordance with an embodiment of the invention.

### DETAILED DESCRIPTION

As discussed hereinabove, the eCommerce environment presents significant challenges to both buyers, due to the complexities of the dynamic nature of market prices and product availability, and sellers, due to the difficultly in efficiently responding to market demand and effectively presenting their offerings to the right buyers at the right time. The method of the invention applies AI-driven negotiation and brokerage to address these issues by streamlining the complex interactions between buyers and sellers in the digital marketplace. By introducing artificial intelligence as a mediator (and negotiator), the process aims to become more efficient, unbiased, and adaptable to market fluctuations, thus enhancing the decision-making process in procurement.

A system and method for streamlining an eCommerce procurement process by leveraging Artificial Intelligence (AI) to 1) facilitate negotiations between buyers and sellers, 2) analyze market trends, and 3) optimize buyer-seller pairings is provided. This system and method provide an efficient, accurate, and timely process for conducting eCommerce transactions to provide benefits to both buyers and sellers in terms of improved deal terms and market adaptability. In an embodiment, the method of the invention addresses the issues using the following four (4) different approaches. The first approach applies a Dynamic Market Analysis (DMA) approach which involves directly addressing the issue that the commercial landscape is characterized by rapidly changing prices and diverse product offerings. The method of the invention uses AI-driven systems to analyze dynamic market conditions in real time and to provide up-to-date information that is crucial to making informed decisions. The second approach involves using an Automated AI Negotiator (or “AI Negotiator”) to address the issue that traditional methods of negotiation are often time-consuming and subject to human biases. Accordingly, the method of the invention ensures that the negotiation process is efficient and unbiased, and that any decision is based on a rational decision-making process which considers a comprehensive analysis of market data and user preferences.

The third approach involves addressing the issue of effectively matching the right buyer with the right seller (and vice versa) in a crowded digital marketplace. Accordingly, the method of the invention uses an AI approach to intelligently match buyers and sellers based on specific needs and offerings, thereby significantly improving the efficiency and accuracy of matching buyers and sellers. The fourth approach is aimed at ensuring that the buyers sign the best deals with suppliers/vendors to buy products at the best possible price and the ensure delivery of the product on time, while taking into consideration vendor reputation, sustainability and other factors based on different aspects of the current situation and the ability to recommend the best deal to the buyer at the time it is needed most. This approach involves providing the buyer with recommendations for the procurement of specific commodities (such as metals/platinum) in advance, based on dynamic real time analytics. The method of the invention monitors the price of such products, analyzes events that may cause/drive a price change, and provides the user with a recommendation and supporting explanation along with the best purchase amount and price.

In an embodiment, the method of the invention involves an AI-driven, unbiased negotiation process that dynamically adapts to real-time market conditions and buyer-seller profiles. The negotiation process operates to understand external forces that will influence the price change on the market by combing information for readily available sources, such as social media, news outlets, and company outlooks/forecasts, understand current market trends and demand from other corporations and entities, understand current consumption and demand shifts and then predicts/forecasts non-anticipated supply distractions along with price projections, provide diverse, non-biased, well-informed viewpoints (both pro and con) and categorize suppliers based on supplier profile and segment according to current market demand. It should be appreciated that segmentation is performed dynamically and can be changed. Moreover, suppliers may be assigned an associated reputational score and sustainability factor (which may be dynamically changed based on the current market situation).

The above may be accomplished via integration of advanced machine learning algorithms for predictive market trend analysis and buyer-seller profile assessment. The user day-to-day behavior and the existing market may be analyzed, based on anticipated events, etc., to provide the best recommendations (like buy a greater quantity than normal due to weather-related issues, pandemic issues, product lifespan issues, etc.) and to identify products/categories to democratize sourcing for products/services that may have a sole source or a sole region for sourcing. Additionally, an automated, intelligent matching software model that pairs buyers with sellers based on optimized negotiation outcomes and comprehensive market analysis may be implemented and may incorporate the use of an AI negotiator software module ‘avatar’ functioning in the role of a procurement buyer having a conversation with the buyers to explain recommendations and the value of the recommendation. Moreover, continuous learning software models may be used to refine negotiation strategies and matching criteria based on ongoing market data and transaction feedback. Moreover, the method of the invention may include implementing scalable architecture that can be adapted across various eCommerce platforms to enhance the procurement process in diverse market segments.

In an embodiment, the method of the invention includes conducting negotiations between buyers and sellers in an eCommerce environment by utilizing an AI Negotiator software module to process market data, generate negotiation strategies, and engage in dynamic, real-time bargaining to reach mutually beneficial agreements. The AI Negotiator software module surrounds the buyer with external influence information (such as data on the weather or other extreme events in that particular area that may create a potential shortage of supply) and presents the buyer with the metrics to explain what is going on, augmenting this information and explanation with visual sensors. The AI Negotiator software module (e.g., an avatar) may use Virtual Realty (VR) to visualize the impact to the buyer if the buyer sources and rationalizes the supply base by procuring, creating, and prioritizing a sourcing pipeline. Moreover, the AI Negotiator software module will also present underlying data and assumptions for the reasoning and influence.

The method of the invention further includes continuously collecting and analyzing market data, including pricing trends and product availability, by employing machine learning algorithms to forecast market dynamics and to inform negotiation strategies, thereby enabling adaptive responses to fluctuating market conditions. Additionally, the method of the invention also intelligently matches buyers with sellers based on a comprehensive analysis of buyer requirements and seller offerings, which are facilitated by the outcomes of AI-driven negotiations informed by ongoing market trend analysis which aim to optimize transaction efficiency and satisfaction for both buyer and seller. Furthermore, the AI Negotiator software module can monitor inventory levels and track product movement by integrating it to Inventory Management Systems to negotiate with different external suppliers to maintain adequate product stock levels.

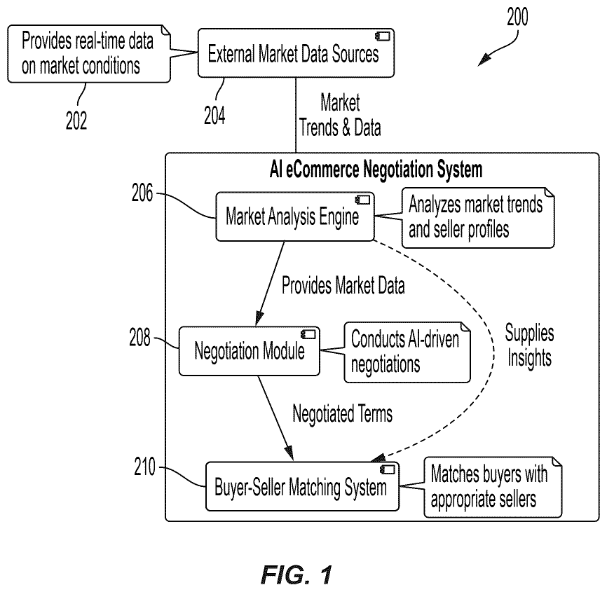

In accordance with an embodiment and referring to FIG. 1, a method 200 for an Autonomous Facilitation of Procurement Negotiation and Transaction in an eCommerce Environment is provided and includes obtaining prerequisite information related to a product to be purchased, such as real time market data (including pricing trends and product availability) 202, which is obtained from external market sources 204. Additional prerequisite information may include buyer profiles and requirements, seller offerings and product information and any feedback data from previous transactions. Once the prerequisite information has been obtained, the information may be introduced to a Market Analysis Software (MAS) engine 206 which continuously scans and analyzes eCommerce market data, including price trends, product availability, and seller profiles, using advanced data analytics and machine learning algorithms. This MAS 206 introduces the analyzed data into an AI Negotiation software module 208 and a Buyer-Seller Matching System (BSMS) software module 210 to provide the BSMS 210 with the necessary insights to make informed decisions and to tailor recommended actions.

In an embodiment, the AI Negotiation software module 208 then utilizes AI algorithms to conduct negotiations between the buyers and the sellers. The AI Negotiation software module 208 processes inputs from the MAS 206 to conduct an unbiased negotiation, aiming for optimal deal terms. The AI Negotiation software module 208 also receives market insights from the MAS 206 and uses those insights to drive the negotiations. The output of the AI Negotiation software module 208, which is in the form of negotiated terms, is then introduced into the Buyer-Seller Matching System software module (BSMS) 210 to finalize transactions. The BSMS 210 analyzes the data that is provided by the MAS 206 along with the results of the AI Negotiation software module 208 to match buyers with the appropriate sellers, responsive to the buyer's requirements and the seller's offerings, using the data provided by the MAS 206 and the results of the AI Negotiation software module 208. It should be appreciated that the BSMS 210 integrates the market analysis and the negotiated terms to effectively match buyers with appropriate sellers. This ensures that the final pairings are optimally aligned with the needs of both the buyer and the seller and with the market conditions.

It should be further appreciated that the BSMS 210 may also generate a ‘knowledge graph’ which reflects potential buyers and sellers and their products/needs along with connections/links for potential supply relationships along the entire supply chain/network. It should be appreciated that a ‘knowledge graph’ may be a logical/historical log of all previous transactions within a product space/business, etc. The ‘knowledge graph’ may also be a knowledge corpus of historical averages and/or it may include predicted and/or generic and crowdsourced data, if actual historical data is not available. Overall, the ‘knowledge graph’ may be used as a data starting point to aid with the matching of potential buyer-seller pairs by ‘seeding’/generating the context of the eCommerce transaction (i.e., the 5 W's & H—What, Where, When, Why, Who, & How) which may provide a reference of when and where the requirements are needed. The connections/links are based on the needs of the potential buyers, and the ability and viability of the sellers to supply those needs. In order to support the search, analysis, and recommendation functions, the nodes of the graph are augmented with material and product details, capabilities, capacities, locations, and other properties of the companies under consideration. These vertices/nodes are thus augmented with data related to the connections such as transport cost, capacity, time, and regulatory issues, tariffs, etc. Moreover, because the data is dynamic and changing in real time, this allows the BSMS 210 to assess supply risks, explore alternatives in cases of supply chain disruptions and adapt to changing conditions, including potential re-factoring and long-term planning. Additionally, this also allows tracing demand from the end users to the origins of materials and components.

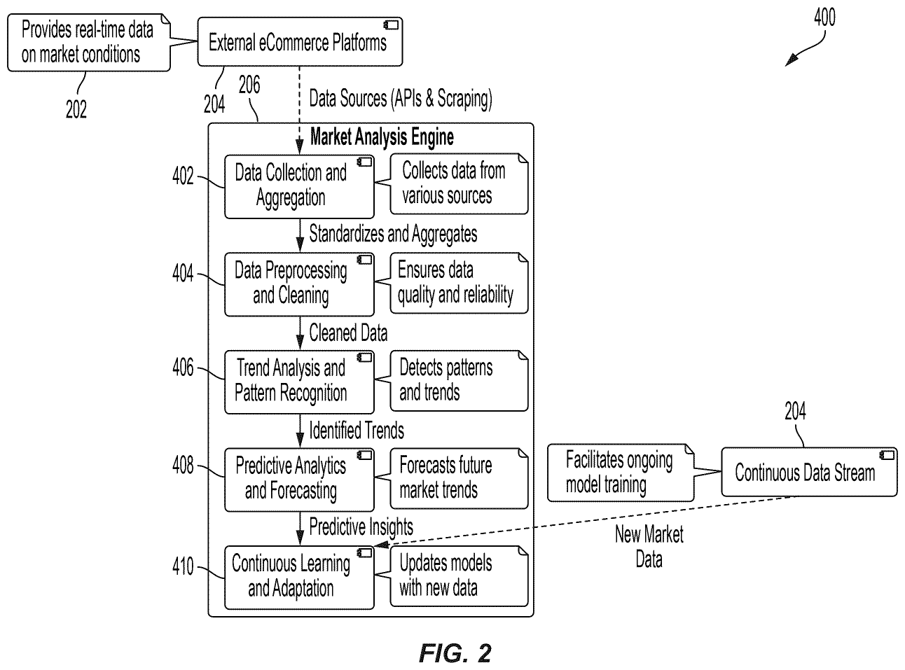

In an embodiment and referring to FIG. 2, a block diagram 400 describing the operation of the MAS 206 is shown and includes collecting and aggregating data, as shown in operational block 402, where the data may be collected from various multiple and readily available data sources 202, 204, such as social media, news outlets, and company outlooks/forecasts, understand current market trends and demand from other corporations and entities. The collected data may include pricing, product specifications, and seller profiles, from various eCommerce platforms prerequisite information related to a product to be purchased, real time market data (including pricing trends and product availability), information about the buyer (i.e., buyer profiles and requirements), the (i.e., seller offerings and product information) and any feedback data from previous transactions. This data collection may be accomplished using well-known web scraping techniques and APIs provided by eCommerce platforms. The collected data is then aggregated and standardized to create a unified data repository to ensure consistency in the data format for further analysis.

In an embodiment, the standardized and aggregated data is then processed and cleaned, as shown in operational block 404, to ensure data quality and reliability. Once the data is aggregated, it undergoes preprocessing to remove any inconsistencies, missing values, or outliers that could skew the analysis. This may be accomplished using techniques such as data normalization and imputation are employed to ensure the quality and reliability of the data. This step is crucial as it has a direct impact on the accuracy of subsequent analyses. Once the data has been ‘cleaned’, the cleaned data is then analyzed to conduct trend analysis and pattern recognition, as shown in operational block 406, to identify market trends, demand patterns and price fluctuations. This may be accomplished using machine learning algorithms, such as time-series analysis and clustering techniques, to detect patterns and trends in the data. These insights are essential for understanding market dynamics and making informed predictions.

In an embodiment, the identified trends are then analyzed to conduct a predictive analysis and forecasting, as shown in operational block 408, to forecast future market trends and price movements. This may be accomplished using advanced machine learning models, such as regression analysis and neural networks. This predictive capability provides forward-looking insights, which are vital for strategic decision-making in procurement of products. The forecasted market trend and price movement data are then provided to a Continuous Learning and Adaptation (CLA) software model, as shown in operational block 410, along with a continuous data stream 202, 204 of new market data, which processes the forecasted market trend and price movement data to allow the invention to continuously ‘learn’, update and adapt to the changing landscape by constantly updating the models based on new data. This ensures that the method remains accurate over time, adapting to any changes in market conditions. Techniques such as online learning and incremental model training may be employed to facilitate this ongoing adaptation.

In accordance with an embodiment, the MAS 206 may employ a variety of Machine Learning Algorithms (such as, k-means clustering for pattern recognition, ARIMA (Auto Regressive Integrated Moving Average) for time-series analysis, and LSTM (Long Short-Term Memory) networks for predictive analytics) and APIs/Data Sources. Additionally, the APIs/Data Sources may include APIs from major eCommerce platforms (like Amazon, eBay, Alibaba) for data collection, as well as open-source web scraping tools like ‘Beautiful Soup’ or ‘Scrapy’ for extracting data from websites. Moreover, the MAS may adhere to IT standards, such as RESTful API principles for data retrieval and JSON or XML formats for data interchange. Also, security protocols like OAuth may be used for secure API interactions, and data storage may comply with standards like SQL for relational databases or NoSQL for unstructured data.

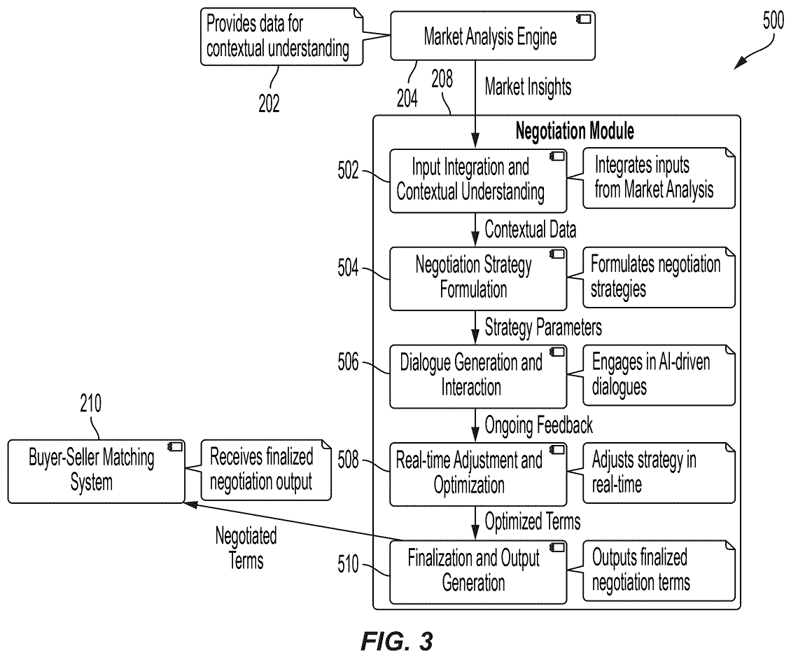

Referring to FIG. 3, a block diagram 500 describing the operation of the AI Negotiation software module 208 is shown and includes receiving and integrating the output data from the MAS 206 responsive to the context of each transaction, as shown in operational block 502, including market trends, product specifics, and buyer and seller profiles, using natural language processing (NLP) and semantic analysis. A negotiation strategy is then formulated, as shown in operational block 504, where the negotiation strategy is based on the contextual data which includes setting initial offer parameters, response tactics, and concession rates using game theory principles and predictive models to anticipate any potential responses from the other party. Using Natural Language Processing (NLP) algorithms, a negotiation dialog with the buyers and sellers is simulated, as shown in operational block 506, to generate simulated responses, counteroffers, and concessions, maintaining a natural, human-like interaction. This may be accomplished using a debater API. Throughout the negotiation, the strategy may be continuously adjusted based on real-time feedback and market changes, as shown in operational block 508, where Machine Learning (ML) models may analyze the ongoing dialogue and external market data to dynamically refine the negotiation approach. Once an agreement is reached, the terms are finalized, and an output is generated, as shown in operational block 510, wherein the output includes the agreed terms, such as price, quantity, and delivery dates, which are then passed to the Buyer-Seller Matching System for transaction finalization, as shown in operational block 512.

In accordance with an embodiment, the AI Negotiation software module 208 may utilize reinforcement learning for strategy optimization, NLP algorithms, such as like BERT (Bidirectional Encoder Representations from Transformers) for dialogue understanding and generation, and predictive analytics for adjusting negotiation tactics. Additionally, the AI Negotiation software module 208 may integrate with APIs from the MAS 206 for real-time market data and may use APIs for communication with the buyers and the sellers. Additionally, data privacy and security compliance, such as GDPR, in handling user data may be ensures due to adherence to communication protocols like WebSocket for real-time interactions and RESTful APIs for data exchange.

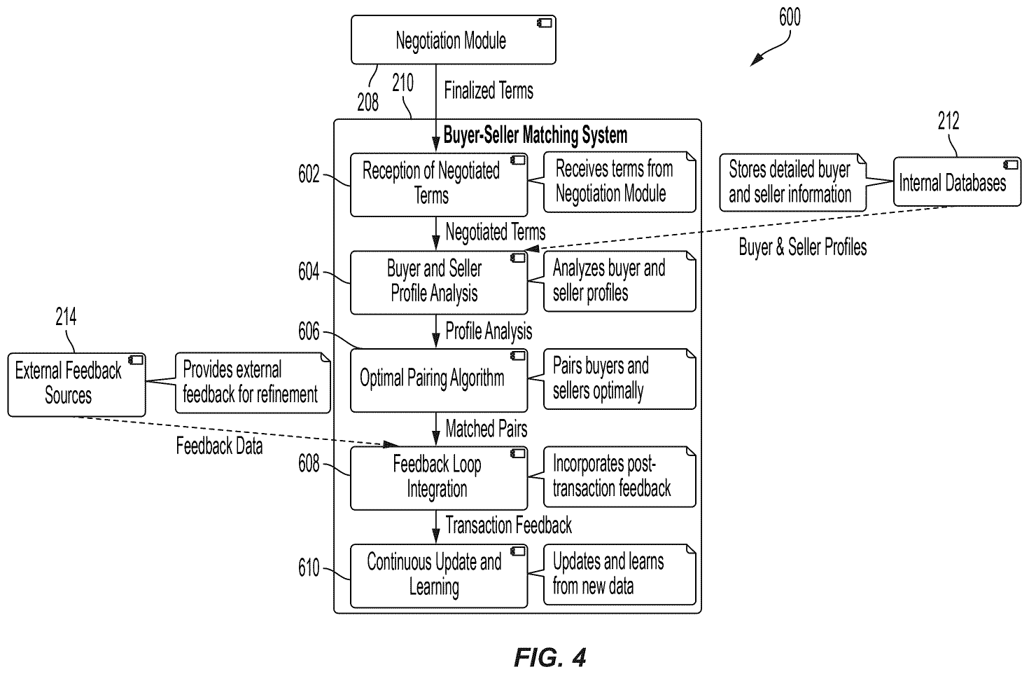

Referring to FIG. 4, a block diagram 600 describing the operation of the Buyer-Seller Matching System (BSMS) software module 210 is shown and includes receiving the negotiated terms from the AI Negotiation software module 208, as shown in operational block 602, where the terms may include finalized prices, quantities, delivery timelines, and other relevant conditions agreed upon during the negotiation phase. Using ML techniques, the profiles of the buyers and the sellers (which may be obtained by internal databases 212 that may include buyer and seller profiles) are analyzed, as shown in operational block 604, to understand buyer needs, preferences, and purchasing history, as well as seller offerings, reputation, and fulfillment capabilities. Buyers may then be paired with sellers based on the analyzed profiles and the negotiated terms using an Optimal Pairing Algorithm, as shown in operational block 606, which considers factors like price suitability, product compatibility, and delivery timelines. This ensures that the most advantageous matches are generated. Post-transaction feedback is generated and incorporated back into the system, as shown in operational block 608, to help in refining future pairings, where the post-transaction feedback may include buyer satisfaction, seller performance, other various external feedback sources 214 and the overall success of the transaction. This helps to identify and select suppliers by searching for and evaluating potential suppliers based on factors such as product quality, pricing, delivery terms and customer service. Moreover, the algorithms are continuously updated, as shown in operational block 610, to allow the method to continuously ‘learn’ based on ongoing transactions and market changes to ensure that the matching process remains efficient in a dynamic eCommerce environment.

In accordance with an embodiment, the BSMS 210 may utilize algorithms such as collaborative filtering for profile analysis and recommendation systems, and decision trees for categorizing and matching buyers and sellers based on multiple criteria. This allows the BSMS 210 to Create Supply Dimension in new Supply Data Hub, Create links for future analytical build out, (code keys for base products, linked to vendors, distributors, service providers, etc. (supplier−>products (cost)−>parts(cost)−>suppliers−>(company details, inventory)−>distribution (shipping, transportation & delivery), Consolidate data into grouping, Use analytics to Understand customer & end consumer demand, Have summary facts around user, business activity and Build the best matching between need and demand with similar comparison. Additionally, the AI Negotiation software module 208 may integrate with internal databases for accessing buyer and seller profiles, and external APIs for real-time market data and feedback collection, as well as ensuring compliance with data privacy standards such as GDPR, by utilizing RESTful APIs for data exchange, and by employing secure communication protocols for data transmission.

In accordance with an embodiment, the final output from the BSMS software module 210 may include optimized negotiation strategies and agreements between buyers and sellers, personalized and predictive market analyses and trend forecasts, precisely matched buyer-seller pairs for transactions (which may be scope specific) and continuous learning insights for system improvement and adaptation.

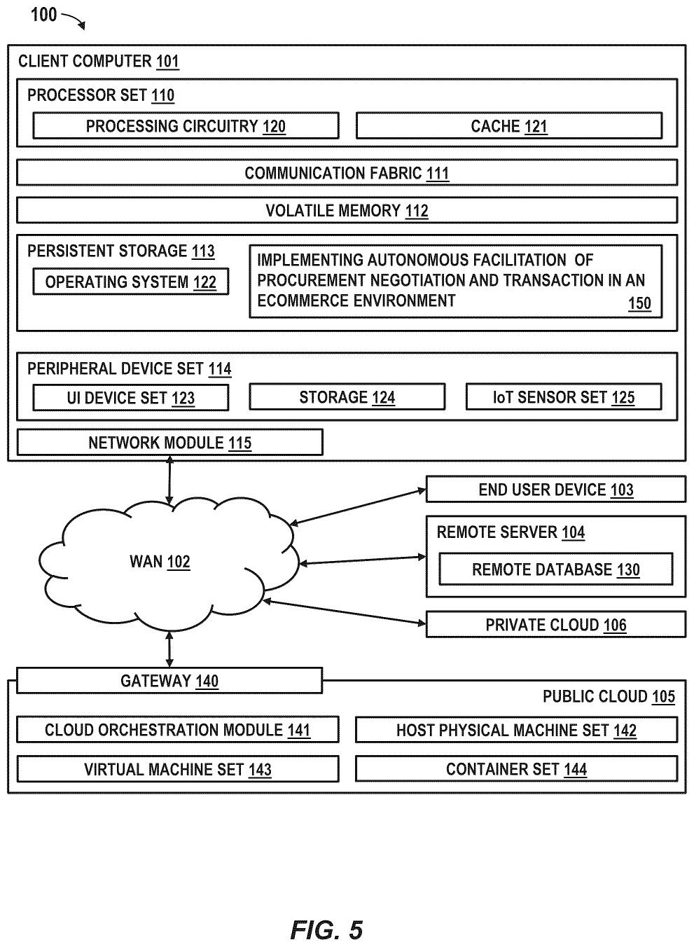

Moreover, it should be appreciated that in one or more embodiments, the computer 100 shown in FIG. 5 may be used, in whole or in part, to practice one or more of the features of the invention. For example, in an embodiment, the computer 100 in FIG. 5 may be used to conduct a user session and may contain the software modules 206, 208, 210 shown in FIGS. 1-4 to practice the invention. The computer 100 in FIG. 5 may further include processors which execute instructions that practice the processes in FIG. 1-4, including the use of machine learning models, such as commonly available AI generative models (LLMs) and the use of reinforcement learning models used it in the step of ranking and updating the dynamic set of recommendations.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as for implementing autonomous facilitation of procurement negotiation and transaction in an eCommerce environment, as shown at block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

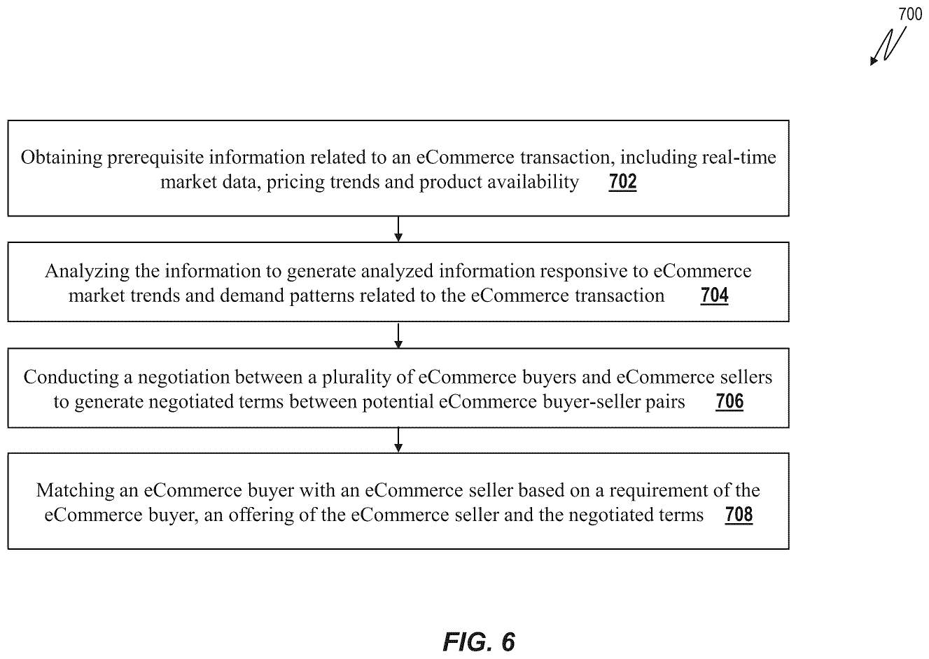

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 6. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip. ” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images. ” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform tasks. More specifically, one or more embodiments described herein can incorporate and utilize rule-based decision making and artificial intelligence (AI) reasoning to accomplish the various operations described herein, namely containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

In accordance with an embodiment, a method 700 for Autonomous Facilitation of Procurement Negotiation and Transaction in an eCommerce Environment is provided, as shown in FIG. 6. The method 700 includes obtaining prerequisite information related to an eCommerce transaction, as shown in operational block 702, wherein the prerequisite information includes real-time market data, pricing trends and product availability. This may be accomplished by collecting the prerequisite information from various multiple and readily available data sources 202, 204, such as social media, news outlets, and company outlooks/forecasts, understand current market trends and demand from other corporations and entities. The collected information may include pricing, product specifications, and seller profiles, from various eCommerce platforms prerequisite information related to a product to be purchased, real time market data (including pricing trends and product availability), information about the buyer (i.e., buyer profiles and requirements), the (i.e., seller offerings and product information) and any feedback data from previous transactions. Additionally, this data collection may be accomplished using well-known web scraping techniques and APIs provided by eCommerce platforms.

The method 700 includes analyzing the prerequisite information using advance data analytic and machine learning algorithms to generate analyzed information responsive to eCommerce market trends and demand patterns related to the eCommerce transaction, as shown in operational block 704. This may be accomplished using advanced machine learning models, such as regression analysis and neural networks. This predictive capability provides forward-looking (forecasting) insights and market trends and price movement data along with a continuous data stream 202, 204 of new market data, which processes the forecasted market trend and price movement data to allow the invention to continuously ‘learn’, update and adapt to the changing landscape by constantly updating the models based on new data. This ensures that the information remains accurate over time, adapting to any changes in market conditions. Techniques such as online learning and incremental model training may be employed to facilitate this ongoing adaptation.

The method 700 further includes conducting a negotiation between a plurality of eCommerce buyers and a plurality of eCommerce sellers using a machine learning algorithm to generate negotiated terms between potential eCommerce buyer-seller pairs, as shown in operational block 706. This may be accomplished via the AI Negotiation software module 208 which receives and integrates data responsive to the context of each transaction, including market trends, product specifics, and buyer and seller profiles, using natural language processing (NLP) and semantic analysis. A negotiation strategy is formulated, where the negotiation strategy is based on the contextual data which includes setting initial offer parameters, response tactics, and concession rates using game theory principles and predictive models to anticipate any potential responses from the other party. Using Natural Language Processing (NLP) algorithms, a negotiation dialog with the buyers and sellers is simulated to generate simulated responses, counteroffers, and concessions, maintaining a natural, human-like interaction. This may be accomplished using a debater API. Throughout the simulated negotiation, the strategy may be continuously adjusted based on real-time feedback and market changes, where Machine Learning (ML) models may analyze the ongoing dialogue and external market data to dynamically refine the negotiation approach. Once an agreement is reached, the terms are finalized, and an output is generated, wherein the output includes the agreed terms, such as price, quantity, and delivery dates.

Additionally, the method 700 includes matching an eCommerce buyer with an eCommerce seller based on a requirement of the eCommerce buyer, an offering of the eCommerce seller, and the negotiated terms, as shown in operational block 708. This may be accomplished using a Buyer-Seller Matching System (BSMS) software module 210 which receives the negotiated terms from the AI Negotiation software module 208, where the terms may include finalized prices, quantities, delivery timelines, and other relevant conditions agreed upon during the negotiation phase. Using ML techniques, the profiles of the buyers and the sellers (which may be obtained by internal databases 212 that may include buyer and seller profiles) are analyzed to understand buyer needs, preferences, and purchasing history, as well as seller offerings, reputation, and fulfillment capabilities. Buyers may then be paired with sellers based on the analyzed profiles and the negotiated terms using an Optimal Pairing Algorithm, which considers factors like price suitability, product compatibility, and delivery timelines. This ensures that the most advantageous matches are generated. Post-transaction feedback is generated and incorporated back into the system to help in refining future pairings, where the post-transaction feedback may include buyer satisfaction, seller performance, other various external feedback sources 214 and the overall success of the transaction. This helps to identify and select suppliers by searching for and evaluating potential suppliers based on factors such as product quality, pricing, delivery terms and customer service. Moreover, the algorithms are continuously updated to allow the method to continuously ‘learn’ based on ongoing transactions and market changes to ensure that the matching process remains efficient in a dynamic eCommerce environment.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration. ” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc.

The terms “a plurality” are understood to include any integer number greater than or equal to two, i.e. two, three, four, five, etc. The term “connection” can include both an indirect “connection” and a direct “connection. ”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein. Moreover, the embodiments or parts of the embodiments may be combined in whole or in part without departing from the scope of the invention.

What is claimed is:

1. A method for Autonomous Facilitation of Procurement Negotiation and Transaction in an eCommerce Environment, the method comprising:
obtaining prerequisite information related to an eCommerce transaction, wherein the prerequisite information includes real-time market data, pricing trends and product availability;
analyzing the prerequisite information using advance data analytic and machine learning algorithms to generate analyzed information responsive to eCommerce market trends and demand patterns related to the eCommerce transaction;
conducting a negotiation between a plurality of eCommerce buyers and a plurality of eCommerce sellers using a machine learning algorithm to generate negotiated terms between potential eCommerce buyer-seller pairs; and
matching an eCommerce buyer with an eCommerce seller based on a requirement of the eCommerce buyer, an offering of the eCommerce seller, and the negotiated terms.

2. The method of claim 1, wherein conducting a negotiation includes generating a negotiation strategy, including initial offer parameters, response tactics, and concession rates using game theory principles and predictive models to anticipate potential party responses.

3. The method of claim 2, wherein generating the negotiation strategy includes
engaging in a simulated negotiation dialogue with the potential eCommerce buyer-seller pairs, wherein the simulated negotiation dialogue includes simulated responses, counter-offers, and concessions between the potential eCommerce buyer-seller pairs, and
adjusting the simulated negotiation dialogue in real-time based on market changes.

4. The method of claim 3, wherein the eCommerce buyer is matched with the eCommerce seller based on an agreement being reached during the simulated negotiation dialogue.

5. The method of claim 1, wherein matching the eCommerce buyer with the eCommerce seller includes generating a knowledge graph containing links connecting potential supply relationships along a supply network with the eCommerce buyer and the eCommerce seller, wherein the links are based on the requirements of the eCommerce buyer and an ability of the eCommerce seller to meet the requirements of the eCommerce buyer.

6. The method of claim 5, wherein vertices of the knowledge graph are augmented with data related to links between the potential supply relationships, wherein the data is updated in real-time and includes transport cost, capacity, time, regulatory issues, and tariffs.

7. The method of claim 5, wherein the data is analyzed to assess supply risks, generate alternative actions in case of supply chain disruptions and to trace demand from an end user to a source of product materials and components.

8. A computing system, comprising:
a processor configured to perform operations for Autonomous Facilitation of Procurement Negotiation and Transaction in an eCommerce Environment, the operations comprising:
obtaining prerequisite information related to an eCommerce transaction, wherein the prerequisite information includes real-time market data, pricing trends and product availability;
analyzing the prerequisite information using advance data analytic and machine learning algorithms to generate analyzed information responsive to eCommerce market trends and demand patterns related to the eCommerce transaction;
conducting a negotiation between eCommerce buyers and eCommerce sellers using a machine learning algorithm to generate negotiated terms between potential eCommerce buyer-seller pairs; and
matching an eCommerce buyer with an eCommerce seller based on a requirement of the eCommerce buyer, an offering of the eCommerce seller, and the negotiated terms.

9. The computing system of claim 8, wherein conducting a negotiation includes generating a negotiation strategy, including initial offer parameters, response tactics, and concession rates using game theory principles and predictive models to anticipate potential party responses.

10. The computing system of claim 9, wherein generating the negotiation strategy includes
engaging in a simulated negotiation dialogue with the potential eCommerce buyer-seller pairs, wherein the simulated negotiation dialogue includes simulated responses, counter-offers, and concessions between the potential eCommerce buyer-seller pairs, and
adjusting the simulated negotiation dialogue in real-time based on market changes.

11. The computing system of claim 10, wherein the eCommerce buyer is matched with the eCommerce seller based on an agreement being reached during the simulated negotiation dialogue.

12. The computing system of claim 8, wherein matching the eCommerce buyer with the eCommerce seller includes generating a knowledge graph containing links connecting potential supply relationships along a supply network with the eCommerce buyer and the eCommerce seller, wherein the links are based on the requirements of the eCommerce buyer and an ability of the eCommerce seller to meet the requirements of the eCommerce buyer.

13. The computing system of claim 12, wherein vertices of the knowledge graph are augmented with data related to links between the potential supply relationships, wherein the data is updated in real-time and includes transport cost, capacity, time, regulatory issues, and tariffs.

14. The computing system of claim 12, wherein the data is analyzed to assess supply risks, generate alternative actions in case of supply chain disruptions and to trace demand from an end user to a source of product materials and components.

15. A computer program product comprising a computer readable storage medium having program instructions embodied therewith, the program instructions executable by a processor to cause the processor to perform operations for Autonomous Facilitation of Procurement Negotiation and Transaction in an eCommerce Environment, the operations comprising:
obtaining prerequisite information related to an eCommerce transaction, wherein the prerequisite information includes real-time market data, pricing trends and product availability;
analyzing the prerequisite information using advance data analytic and machine learning algorithms to generate analyzed information responsive to eCommerce market trends and demand patterns related to the eCommerce transaction;
conducting a negotiation between eCommerce buyers and eCommerce sellers using a machine learning algorithm to generate negotiated terms between potential eCommerce buyer-seller pairs; and
matching an eCommerce buyer with an eCommerce seller based on a requirement of the eCommerce buyer, an offering of the eCommerce seller, and the negotiated terms.

16. The computer program product of claim 15, wherein conducting a negotiation includes generating a negotiation strategy, including initial offer parameters, response tactics, and concession rates using game theory principles and predictive models to anticipate potential party responses.

17. The computer program product of claim 16, wherein generating the negotiation strategy includes
engaging in a simulated negotiation dialogue with the potential eCommerce buyer-seller pairs, wherein the simulated negotiation dialogue includes simulated responses, counter-offers, and concessions between the potential eCommerce buyer-seller pairs, and
adjusting the simulated negotiation dialogue in real-time based on market changes.

18. The computer program product of claim 17, wherein the eCommerce buyer is matched with the eCommerce seller based on an agreement being reached during the simulated negotiation dialogue.

19. The computer program product of claim 15, wherein matching the eCommerce buyer with the eCommerce seller includes generating a knowledge graph containing links connecting potential supply relationships along a supply network with the eCommerce buyer and the eCommerce seller, wherein the links are based on the requirements of the eCommerce buyer and an ability of the eCommerce seller to meet the requirements of the eCommerce buyer.

20. The computer program product of claim 19, wherein vertices of the knowledge graph are augmented with data related to links between the potential supply relationships, wherein the data is
updated in real-time and includes transport cost, capacity, time, regulatory issues, and tariffs, and
analyzed to assess supply risks, generate alternative actions in case of supply chain disruptions and to trace demand from an end user to a source of product materials and components.
